(19) United States
(12) Patent Application Publication
(10) Pub. No.: US 2026/0142393 A1
(43) Pub. Date: May 21, 2026

(54) LEVER-TYPE CONNECTOR

(71) Applicant: SUMITOMO WIRING SYSTEMS, LTD., Mie (JP)

(72) Inventors: Tsuyoshi MASE, Mie (JP); Toshihiro ITO, Mie (JP); Takahiro KIKUCHI, Mie (JP); Yoichi TAKAGI, Mie (JP)

(21) Appl. No.: 19/119,407

(22) PCT Filed: Oct. 16, 2023
(86) PCT No.: PCT/JP2023/037375

§ 371 Date: Apr. 9, 2025

(30) Foreign Application Priority Data
Oct. 18, 2022 (JP) 2022-166802

(51) Int. Cl. H01R 12/70; H01R 13/629; H01R 13/641; H01R 13/66

(52) U.S. Cl. CPC H01R 12/7005; H01R 13/62955; H01R 13/641; H01R 13/665

(57) ABSTRACT

A lever-type connector connectable to a mating connector includes a housing, a lever mounted on the housing rotatably between a connection start position and a connection completion position, and a detecting member mounted in the housing movably between a standby position and a detection position and allowed to move from the standby position to the detection position with the lever located at the connection completion position. The housing includes a first locking portion for restricting a movement of the detecting member from the standby position to the detection position by being locked to the detecting member with the lever located at the connection start position and a lock arm for locking the lever with the lever located at the connection completion position.

### TECHNICAL FIELD

The present disclosure relates to a lever-type connector.

### BACKGROUND

A connector described in Japanese Patent Laid-Open Publication No. 2009-043464 (Patent Document 1 below) is known as a connector provided with a detecting member. This connector is provided with a pair of male and female housings connectable to each other and the detecting member mounted in the female housing movably between a standby position and a detection position. At the standby position, a temporary locking portion of the detecting member is locked to a stopper edge of the female housing to restrict a movement of the detecting member to the detection position. If the both housings are properly connected, a butting portion of the male housing interferes with the temporary locking portion and a locked state of the temporary locking portion and the stopper edge is released. In this way, a movement of the detecting member to the detection position is enabled and it can be detected that the both housings are in a properly connected state.

### PRIOR ART DOCUMENT

### Patent Document

Patent Document 1: JP 2009-043464 A

### SUMMARY OF THE INVENTION

### Problems to be Solved

However, in the above configuration, the butting portion starts to ride on a first tapered surface of the temporary locking portion and a locking margin of the temporary locking portion and the stopper edge is reduced if the both housings approach the properly connected state. Thus, in a state where the both housings are nearly properly connected, the detecting member may possibly move to the detection position although the both housings are not properly connected, for example, if the detecting member is strongly pushed in. Also in a lever-type connector provided with a detecting member, the same problem as the one described above is considered.

### Means to Solve the Problem

The present disclosure is directed to a lever-type connector connectable to a mating connector, the lever-type connector being provided with a housing, a lever mounted on the housing rotatably between a connection start position and a connection completion position, and a detecting member mounted in the housing movably between a standby position and a detection position, the detecting member being allowed to move from the standby position to the detection position with the lever located at the connection completion position, the housing including a first locking portion for restricting a movement of the detecting member from the standby position to the detection position by being locked to the detecting member with the lever located at the connection start position and a lock arm for locking the lever with the lever located at the connection completion position, the lock arm including a second locking portion for restricting the movement of the detecting member from the standby position to the detection position by locking the detecting member, the second locking portion being disposed to be lockable to the detecting member by the lock arm sliding in contact with the lever to be deflected and deformed in a rotation process of the lever from the connection start position toward the connection completion position, and the first locking portion being disposed to be lockable to the detecting member until the second locking portion becomes lockable to the detecting member in the rotation process of the lever from the connection start position toward the connection completion position.

### Effect of the Invention

According to the present disclosure, it is possible to provide a lever-type connector easily improved in connection detection reliability.

### BRIEF DESCRIPTION OF THE DRAWINGS

FIG. 1 is a perspective view of a lever-type connector according to an embodiment and a mating connector.

FIG. 2 is a back view of the lever-type connector and the mating connector.

FIG. 3 is a plan view of the lever-type connector and the mating connector.

FIG. 4 is a perspective view showing a lock arm, a first pressing portion and a second pressing portion.

FIG. 5 is a perspective view showing a detecting member mounted at a standby position in a housing.

FIG. 6 is a section along A-A of FIG. 3.

FIG. 7 is a view showing a state where a lever is at a connection completion position in a cross-section along A-A of FIG. 3.

FIG. 8 is a section along B-B of FIG. 3.

FIG. 9 is a section along C-C of FIG. 3.

FIG. 10 is a section along D-D of FIG. 3.

FIG. 11 is a view showing a state where the lever is rotated toward the connection completion position from a state of FIG. 9 and a first locking portion and a locking projection are locked in a cross-section along C-C of FIG. 3.

FIG. 12 is a view showing a state where the first pressing portion is pressing a deflecting piece at the same rotation angle as in FIG. 11 in a cross-section E-E of FIG. 3.

FIG. 13 is a view showing a state where the lever is rotated toward the connection completion position from the state of FIG. 11 and the locking of the first locking portion and the locking projection is released in the cross-section C-C of FIG. 3.

FIG. 14 is a view showing a state where the second pressing portion is pressing the deflecting piece at the same rotation angle as in FIG. 13 in a cross-section D-D of FIG. 3.

FIG. 15 is a view showing the state where the lever is at the connection completion position in the cross-section along C-C of FIG. 3.

FIG. 16 is a view showing the state where the lever is at the connection completion position in the cross-section along D-D of FIG. 3.

FIG. 17 is a view showing the state where the lever is at the connection completion position in the cross-section E-E of FIG. 3.

FIG. 18 is a view showing a state where the detecting member is at a detection position in the cross-section C-C of FIG. 3.

FIG. 19 is a view showing the state where the detecting member is at the detection position in the cross-section D-D of FIG. 3.

FIG. 20 is a perspective view of the detecting member.

### DETAILED DESCRIPTION TO EXECUTE THE INVENTION

### Description of Embodiments of Present Disclosure

First, embodiments of the present disclosure are listed and described.
(1) The lever-type connector of the present disclosure is connectable to a mating connector and provided with a housing, a lever mounted on the housing rotatably between a connection start position and a connection completion position, and a detecting member mounted in the housing movably between a standby position and a detection position, the detecting member being allowed to move from the standby position to the detection position with the lever located at the connection completion position, the housing including a first locking portion for restricting a movement of the detecting member from the standby position to the detection position by being locked to the detecting member with the lever located at the connection start position and a lock arm for locking the lever with the lever located at the connection completion position, the lock arm including a second locking portion for restricting the movement of the detecting member from the standby position to the detection position by locking the detecting member, the second locking portion being disposed to be lockable to the detecting member by the lock arm sliding in contact with the lever to be deflected and deformed in a rotation process of the lever from the connection start position toward the connection completion position, and the first locking portion being disposed to be lockable to the detecting member until the second locking portion becomes lockable to the detecting member in the rotation process of the lever from the connection start position toward the connection completion position.

According to this configuration, since the lock arm includes the second locking portion and the second locking portion is disposed to be lockable to the detecting member by the deflection and the deformation of the lock arm, even if the detecting member is strongly pushed in with the lever-type connector and the mating connector nearly properly connected, a movement of the detecting member from the standby position to the detection position is restricted by the second locking portion. On the other hand, if the lever-type connector and the mating connector are properly connected, the lock arm resiliently returns, the second locking portion is separated from the detecting member, and the detecting member becomes movable to the detection position. By providing the second locking portion lockable to the detecting member as the lock arm is deflected and deformed in this way, the reliability of connection detection of the lever-type connector can be improved.
(2) Preferably, the detecting member includes a body portion, a deflectable and deformable arm portion extending from the body portion and a locking projection disposed on a tip part of the arm portion, the body portion is lockable to the second locking portion, the locking projection is locked to the first locking portion with the lever located at the connection start position, and the locking projection interferes with the mating connector and the arm portion is deflected and deformed in the rotation process of the lever from the connection start position toward the connection completion position, whereby locking of the locking projection and the first locking portion is released.

According to this configuration, as the connection of the lever-type connector and the mating connector proceeds, the locking of the first locking portion and the locking projection can be released. Further, even if the locking of the first locking portion and the locking projection is released, the second locking portion and the body portion can be lockable.
(3) Preferably, the above lever-type connector is further provided with a detection terminal held in the housing, the detection terminal forming a detection circuit by contacting a mating detection terminal provided in the mating connector, the lock arm is disposed to face the detection terminal, the lever includes a pressing portion for separating the detection terminal from the mating detection terminal by pressing the lock arm toward the detection terminal, and pressing of the lock arm by the pressing portion is released and the detection terminal contacts the mating detection terminal when the lever reaches the connection completion position.

According to this configuration, if the lever-type connector and the mating connector are properly connected, the lock arm resiliently returns and the detection terminal and the mating detection terminal contact to form the detection circuit. Therefore, connection detection can be made also by the detection circuit in addition to by the detecting member.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

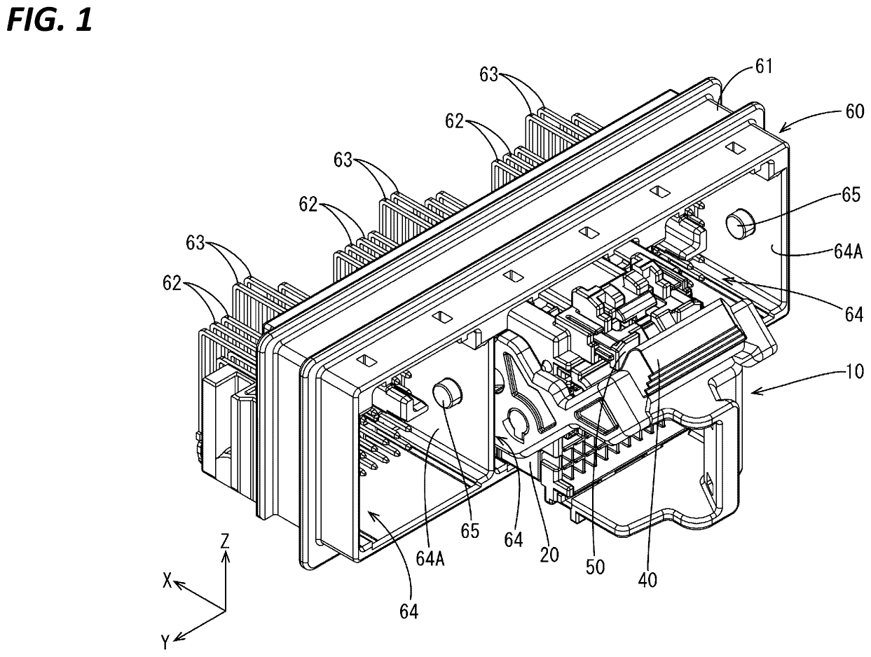

The embodiment of the present disclosure is described with reference to FIGS. 1 to 20. In the following description, a direction indicated by an arrow Z is an upward direction, a direction indicated by an arrow X is a forward direction and a direction indicated by an arrow Y is a leftward direction. Note that, for a plurality of identical members, only some members may be denoted by a reference sign and the other members may be denoted by the reference sign. As shown in FIG. 1, a mating connector 60 connectable to the lever-type connector 10 is a board connector mounted on a circuit board (not shown). In this embodiment, three lever-type connectors 10 are fittable into one mating connector 60. Only the lever-type connector 10 to be fit into a central part of the mating connector 60 is shown in figures.

### Mating Connector

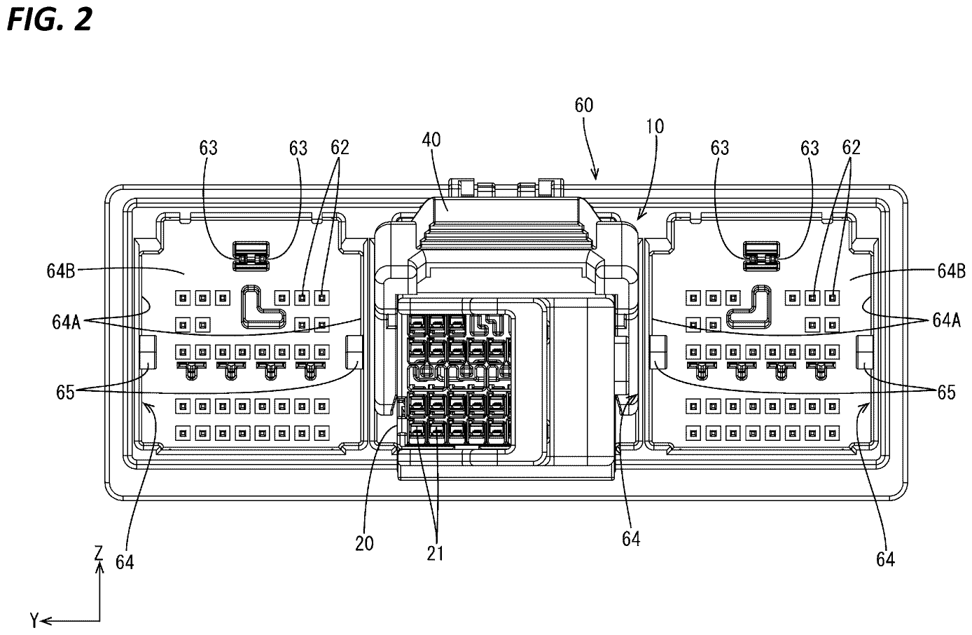

The mating connector 60 is provided with a mating housing 61 and a plurality of mating terminals 62 and a plurality of mating detection terminals 63 held in the mating housing 61. The mating housing 61 is made of synthetic resin and has a laterally long rectangular shape as a whole. As shown in FIGS. 1 and 2, the mating housing 61 is provided with a plurality of fitting recesses 64, into which the lever-type connectors 10 are fittable. A pair of cam pins 65 are provided on both side walls 64A constituting both left and right sides of the fitting recess 64. The pair of cam pins 65 are provided with one on each side wall 64A, and bilaterally symmetrically disposed. The cam pin 65 is formed into a cylindrical shape.

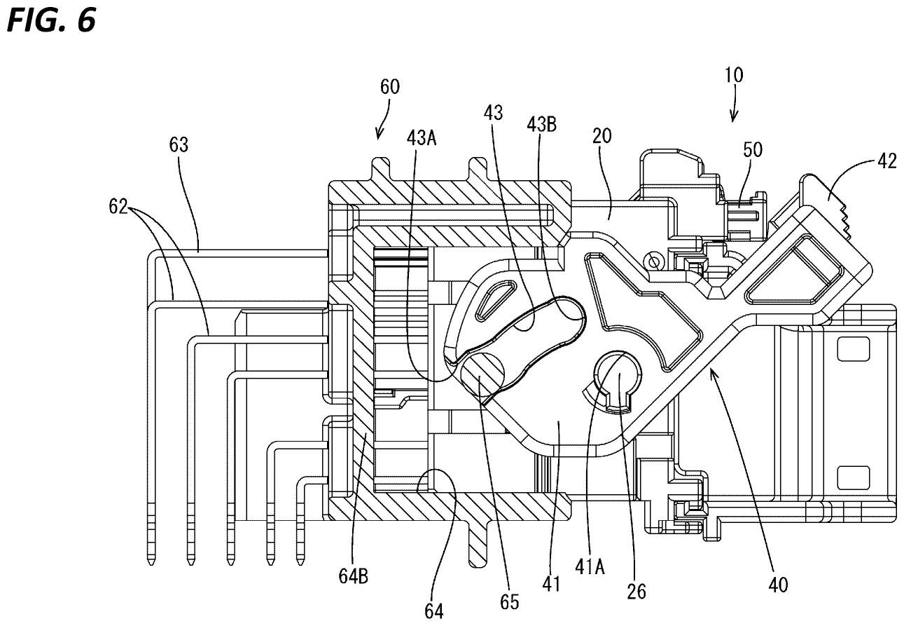

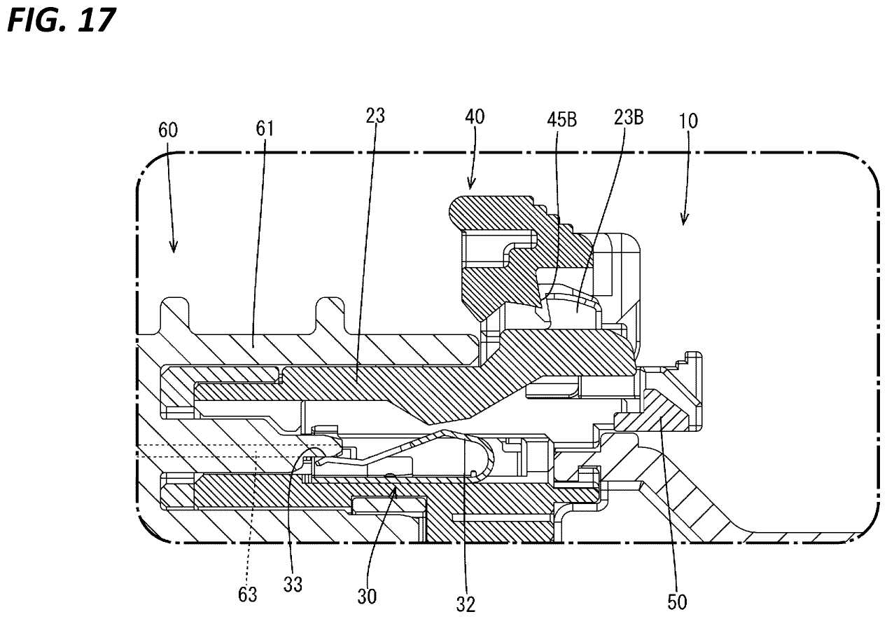

As shown in FIG. 6, the mating terminals 62 and the mating detection terminals 63 are constituted by needle-like terminals made of metal, and held on a back wall 64B constituting the fitting recess 64 while being passed through the back wall 64B in a front-rear direction. One end of each of the mating terminals 62 and the mating detection terminals 63 projects into the fitting recess 64 from the back wall 64B and extends in the front-rear direction. The other end of each of the mating terminals 62 and the mating detection terminals 63 is disposed outside the fitting recess 64 and bent downward. The mating detection terminal 63 is electrically connected to a detection terminal 30 provided in the lever-type connector 10 as the mating connector 60 and the lever-type connector 10 are properly connected (see FIG. 17).

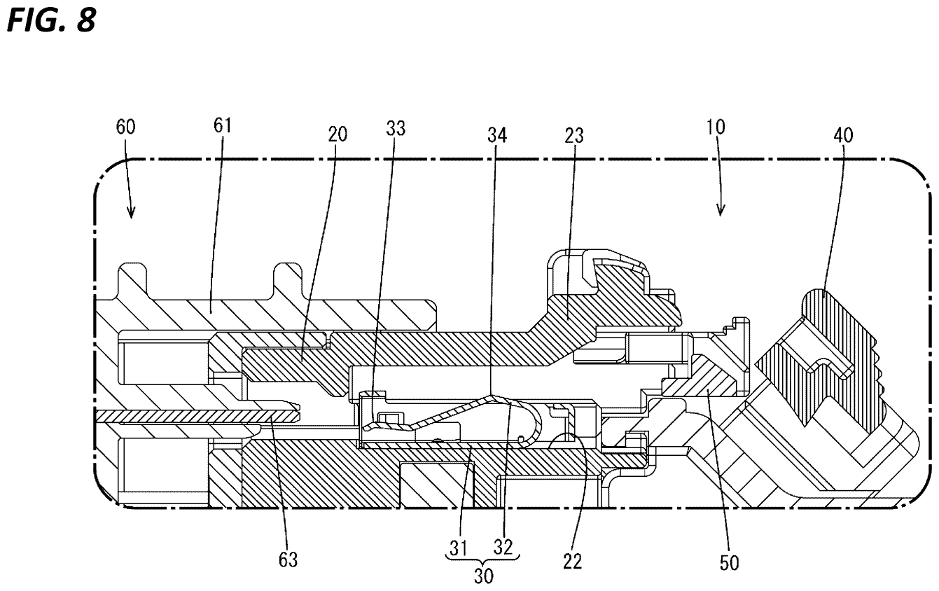

FIG. 8 is a section and, therefore, shows only one mating detection terminal 63. However, as shown in FIGS. 1 and 2, the mating housing 61 holds two mating detection terminals 63 at an interval in a width direction in one fitting recess 64. The two mating detection terminals 63 are connected to a detection circuit of a device. The two mating detection terminals 63 are not electrically connected (a detection circuit is off) until being contacted by the detection terminals 30 of the lever-type connector 10, but the detection circuit is formed if the detection terminals 30 contact both of the two mating detection terminals 63.

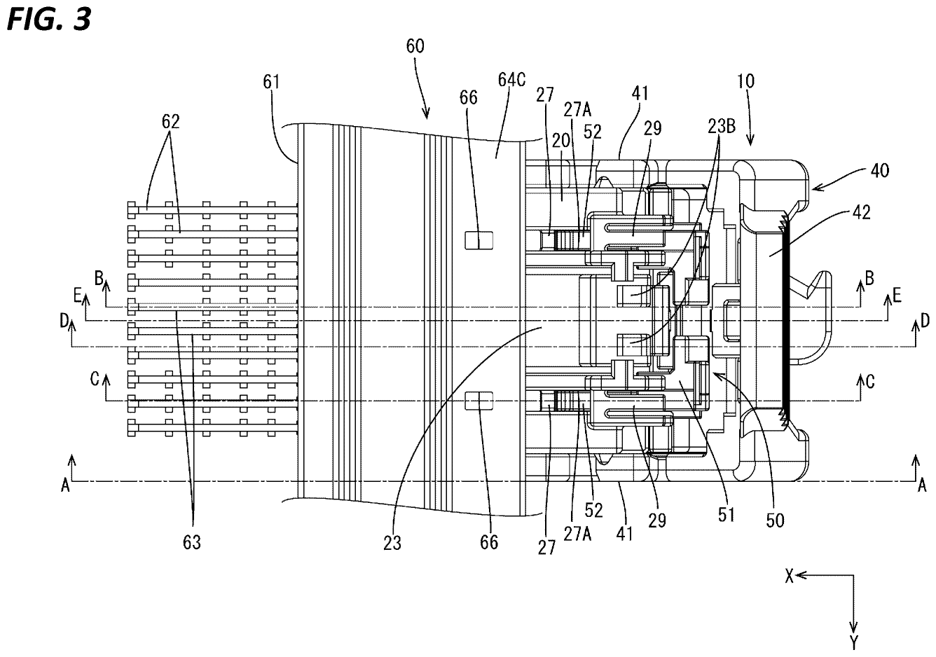

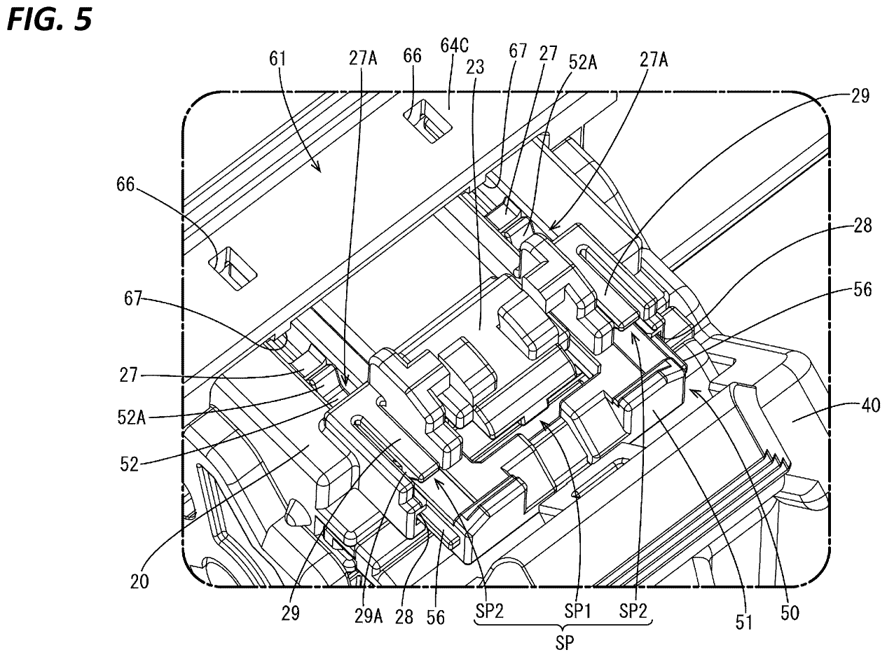

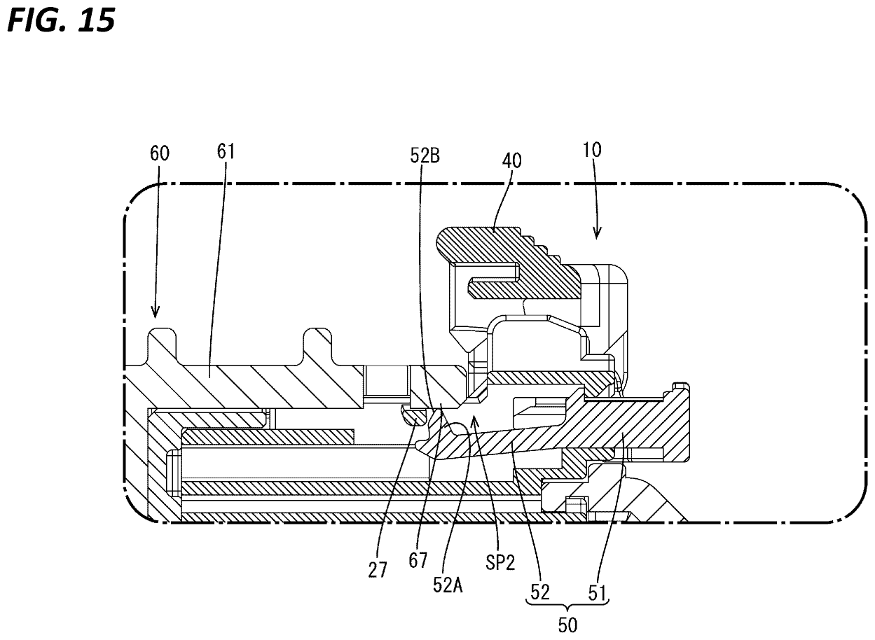

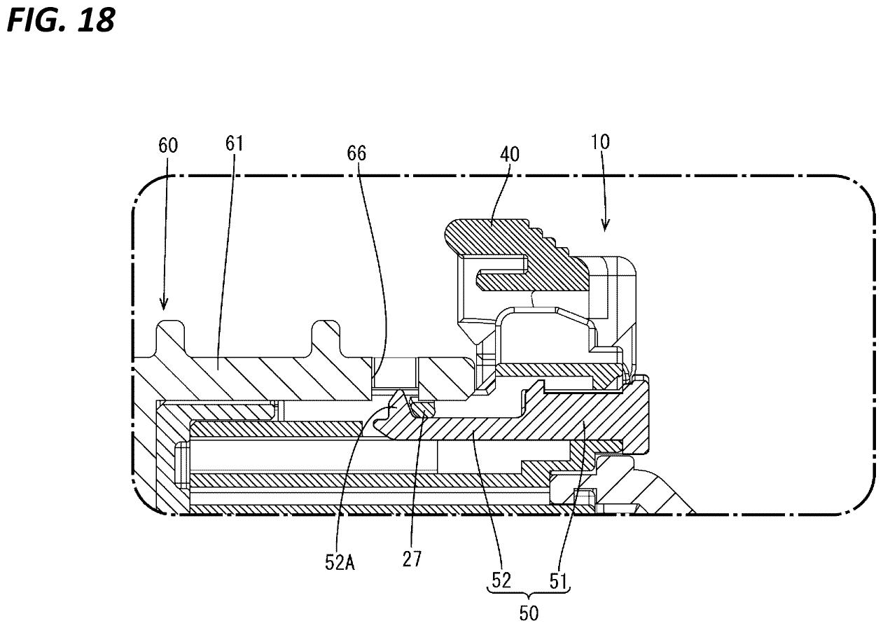

As shown in FIGS. 3 and 5, the mating housing 61 is provided with window portions 66 penetrating through an upper wall 64C of the fitting recess 64 in a vertical direction. As described later, the window portions 66 receive locking projections 52A of a detecting member 50 (see FIG. 18). As shown in FIG. 5, the mating housing 61 is provided with releasing projections 67 projecting downward from the lower surface of the upper wall 64C on the rear end of the upper wall 64C. As described later, the releasing projection 67 is a member for releasing the locking of a first locking portion 27 and the locking projection 52A (see FIG. 15).

### Lever-Type Connector

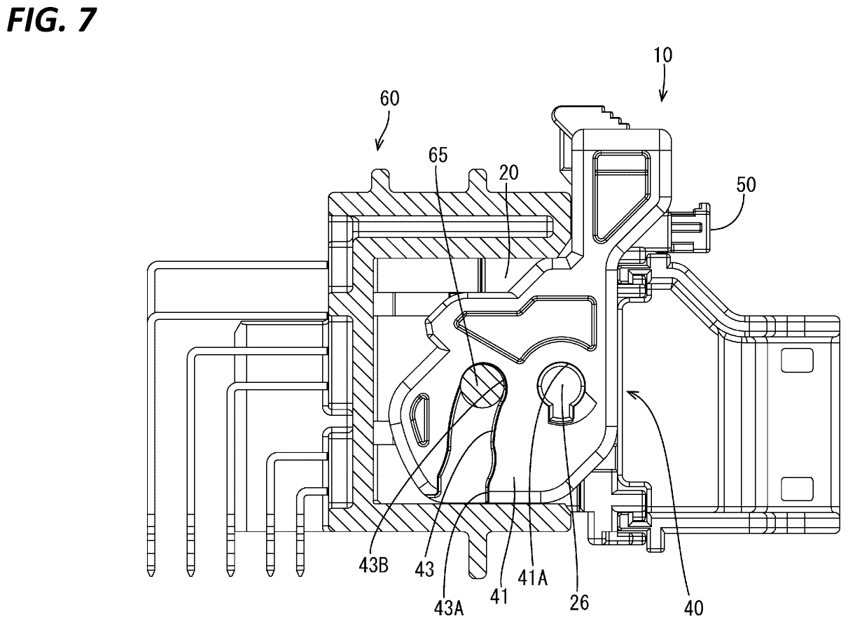

The lever-type connector 10 is, as shown in FIG. 1, provided with a housing 20, a plurality of terminals (not shown), the detection terminal 30 (see FIG. 8), a lever 40 and the detecting member 50. The terminal is a female terminal and connected to the mating terminal 62. The lever 40 is rotatable between a connection start position shown in FIG. 6 and a connection completion position shown in FIG. 7. The lever-type connector 10 is fit into the mating connector 60 if the lever 40 is moved from the connection start position to the connection completion position, and the lever-type connector 10 is separated from the mating connector 60 if the lever 40 is conversely moved from the connection completion position to the connection start position.

### Housing

The housing 20 is made of synthetic resin and, as shown in FIG. 2, in the form of a substantially rectangular block. The housing 20 is provided with terminal accommodating portions 21 penetrating in the front-rear direction to accommodate the terminals. As shown in FIG. 8, the housing 20 is provided with detection terminal accommodating portions 22 penetrating in the front-rear direction to accommodate the detection terminals 30. The detection terminal accommodating portions 22 are disposed on an upper side and a lateral central part of the housing 20.

### Lock Arm

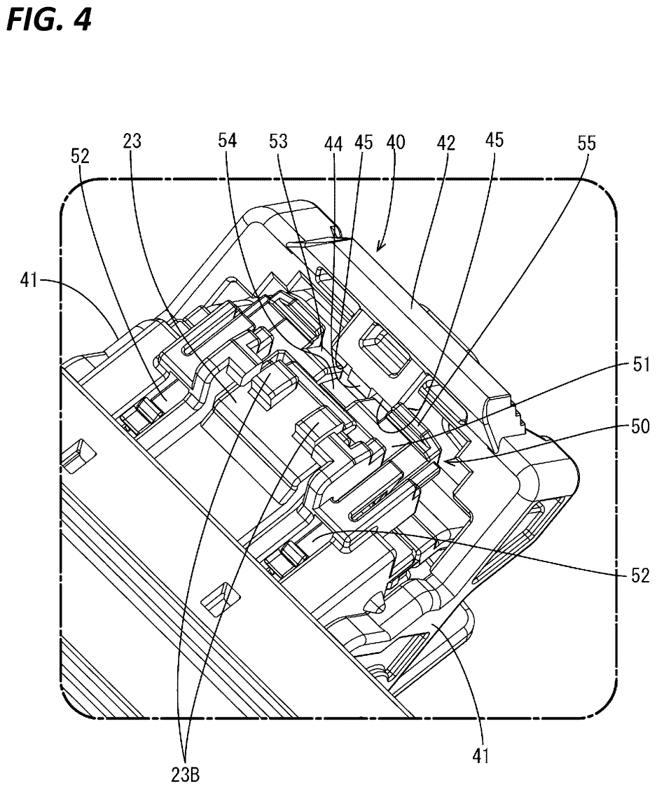

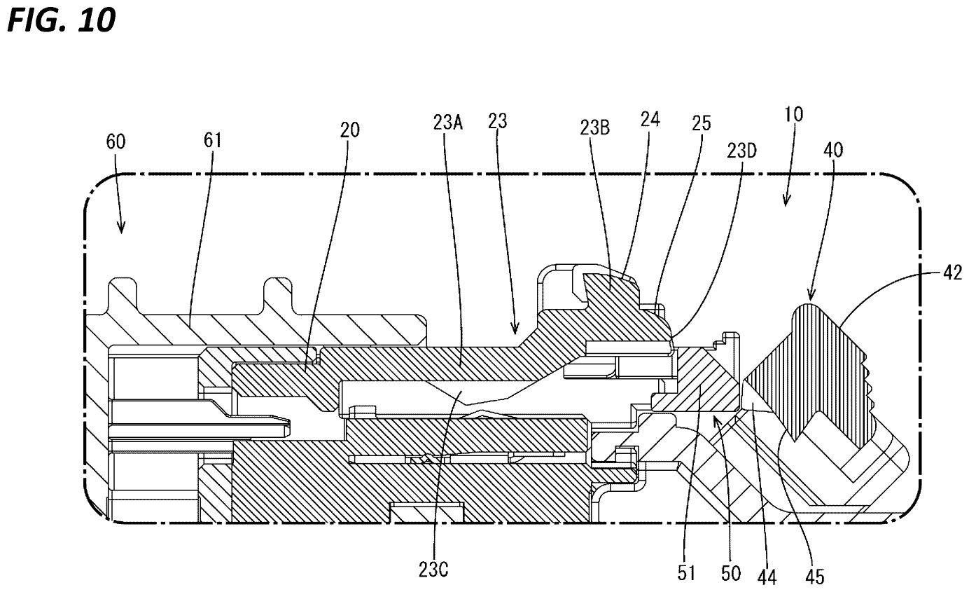

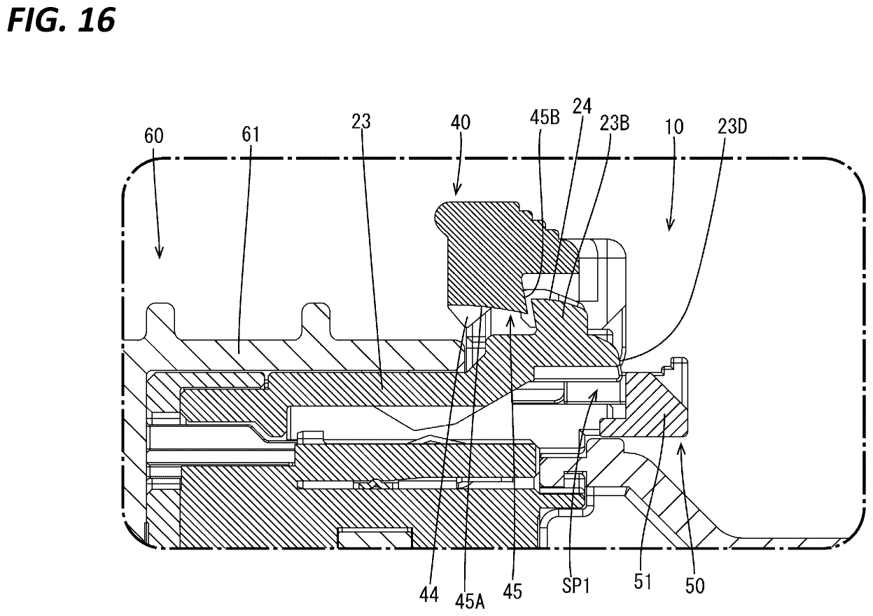

As shown in FIG. 10, the housing 20 is provided with a lock arm 23 extending rearward from the upper wall of the housing 20. The lock arm 23 is provided to be deflectable and deformable in the vertical direction with a front end part connected to the upper wall of the housing 20 as a base end. The lock arm 23 includes a lock arm body 23 A and fitting lock portions 23B projecting upward from a rear part of the lock arm body 23A. As shown in FIGS. 3 and 4, the lock arm 23 of this embodiment is provided with two fitting lock portions 23B at an interval in the lateral direction. The fitting lock portions 23B are locked to a locking portion 45B provided on the lever 40 with the lever-type connector 10 and the mating connector 60 properly connected (see FIG. 16).

As shown in FIG. 10, the upper surface of the fitting lock portion 23B serves as a sliding contact portion 24 in the form of a curved surface convex upward. A press starting portion 25 having a rounded shape is provided on an upper side part of a rear end part of the lock arm 23.

### Second Locking Portion

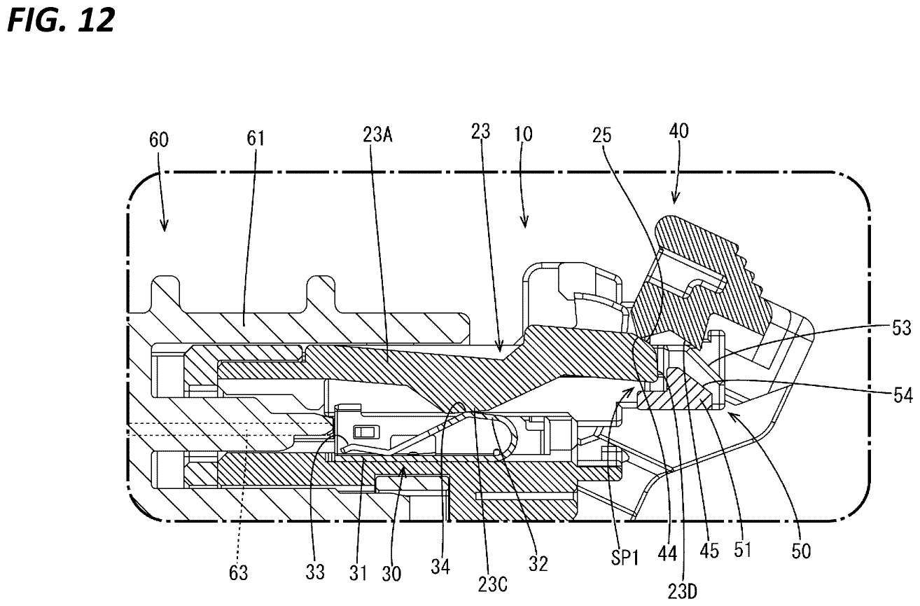

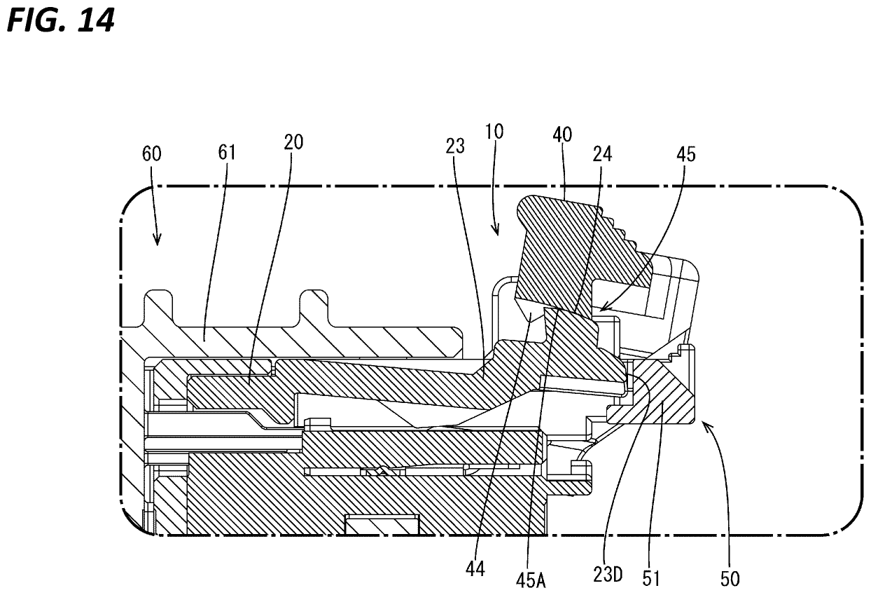

The rear end surface of the lock arm 23 serves as a second locking portion 23D. As described later, the second locking portion 23D is disposed to be lockable to the detecting member 50 in a deflected and deformed state of the lock arm 23 (see FIGS. 12 and 14).

As shown in FIG. 5, the housing 20 includes an accommodation space SP capable of accommodating the detecting member 50. The accommodation space SP includes a first accommodation space SP1 and a pair of second accommodation spaces SP2. The first accommodation space SP1 is provided below a part near a rear end part of the lock arm 23. The second accommodation spaces SP2 communicate with the first accommodation space SP1 and are provided on both sides of the first accommodation space SP1.

### First Locking Portions

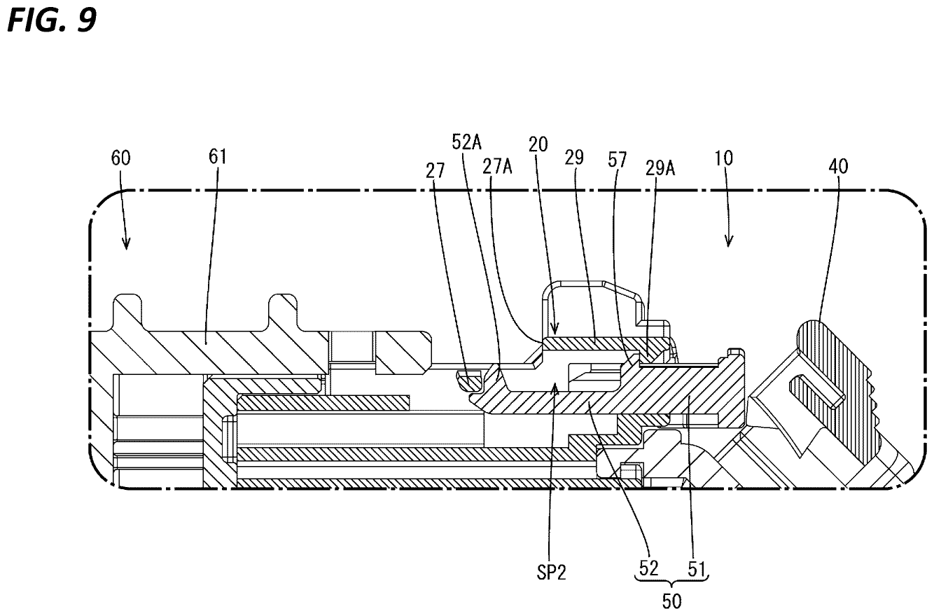

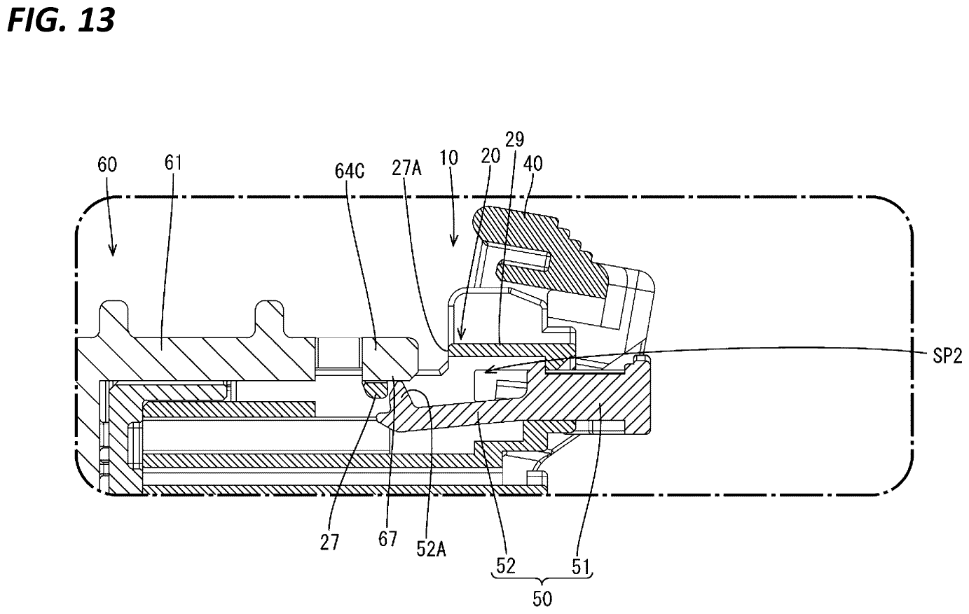

As shown in FIGS. 5 and 9, the housing 20 is provided with the first locking portions 27 disposed at positions near front end parts of the second accommodation spaces SP2. The first locking portion 27 extends in a width direction (lateral direction) and is connected to an inner wall constituting the second accommodation space SP2. The housing 20 includes openings 27A behind the first locking portions 27. These openings 27A are open in the vertical direction and allow communication between the second accommodation spaces SP2 and an outside space (see FIG. 13).

As shown in FIG. 5, the housing 20 is provided with engaging recesses 28 disposed in side parts of the second accommodation spaces SP2. In particular, the housing 20 is provided with the engaging recess 28 disposed in a right side part of the right second accommodation space SP2 and the engaging recess 28 disposed in a left side part of the left second accommodation space SP2. The engaging recess 28 has a groove-like structure and is recessed laterally from the lateral inner wall of the second accommodation space SP2.

As shown in FIGS. 5 and 9, the housing 20 is provided with temporary locking arm portions 29 defining rear halves of the second accommodation spaces SP2 from above. The temporary locking arm portion 29 has a shape elongated in the front-rear direction and is configured to be deflectable and deformable in the vertical direction with a front end part connected to the upper wall of the housing 20 as a base end. As shown in FIG. 9, a rear end part of the temporary locking arm portion 29 is provided with a temporary locking projection 29A projecting downward from the lower surface of the temporary locking arm portion 29. A rear end part of the temporary locking projection 29A is inclined to be located lower toward the front. The front end surface of the temporary locking projection 29A is an upright surface substantially orthogonal to an axis extending in the front-rear direction.

As shown in FIG. 8, the lock arm 23 is disposed to partition an upper part of the detection terminal accommodating portion 22. As shown in FIG. 12, the lock arm 23 is provided with a projection 23C projecting inwardly of the detection terminal accommodating portion 22 from the lock arm body 23A. The lock arm 23 is deflected and deformed downward, whereby the projection 23C presses the detection terminal 30.

### Detection Terminal

As shown in FIG. 8, the detection terminal 30 is formed, such as by bending an electrically conductive metal plate into a predetermined shape and includes a base plate portion 31 to be disposed along the lower inner surface of the detection terminal accommodating portion 22 and a spring portion 32 bent into a predetermined shape by being folded forward from the rear end of the base plate portion 31. The spring portion 32 includes contact point portions 33 disposed near a front end part of the spring portion 32 and an engaging portion 34 disposed in a rear part of the spring portion 32. The contact point portions 33 and the engaging portion 34 are bent into a chevron shape projecting upward. The spring portion 32 is forked on a tip side (front end side) and a pair of left and right contact point portions 33 are provided.

As shown in FIG. 17, if the lever-type connector 10 and the mating connector 60 are properly connected, each contact point portion 33 contacts the mating detection terminal 63. In this way, the two mating detection terminals 63 are electrically connected to the detection terminal 30 to form the detection circuit.

As shown in FIG. 12, the engaging portion 34 is pressed by the projection 23C of the lock arm 23. The engaging portion 34 is pressed by the projection 23C, whereby the contact point portions 33 are displaced toward the base plate portion 31.

As shown in FIGS. 6 and 7, a pair of rotary shafts 26 projecting outwardly of the housing 20 in the lateral direction are provided on both side surfaces of the housing 20. The pair of rotary shafts 26 are provided with one on each side surface and bilaterally symmetrically disposed.

### Lever

The lever 40 is rotatably supported on the housing 20 and functions as a booting mechanism by being operated when the lever-type connector 10 is connected to and separated from the mating connector 60. The lever 40 rotates in a range from the connection start position shown in FIG. 6 to the connection completion position shown in FIG. 7. That is, if the lever 40 is rotated counterclockwise from the connection start position to the connection completion position, the lever-type connector 10 is properly connected to the mating connector 60.

The lever 40 is made of synthetic resin. As shown in FIGS. 3 and 4, the lever 40 is provided with a pair of cam plates 41 and an operating portion 42 coupling tip parts of the pair of cam plates 41 to each other, and gate-shaped as a whole.

As shown in FIGS. 6 and 7, each cam plate 41 is formed with a shaft hole 41A penetrating through the cam plate 41. The rotary shafts 26 are inserted into the shaft holes 41A. The lever 40 is supported on the housing 20 rotatably around the rotary shafts 26.

The cam plate 41 includes a track 43, into which the cam pin 65 enters. The track 43 includes an entrance 43A open forward on the outer edge of the cam plate 41, and is formed to approach the shaft hole 41A from the entrance 43A toward a final end 43B. If the lever-type connector 10 and the mating connector 60 are lightly connected when the lever 40 is at the connection start position, the cam pins 65 enter the entrances 43 A of the tracks 43 as shown in FIG. 6.

If the lever 40 is moved from the connection start position to the connection completion position, the cam pins 65 are engaged with the inner walls of the tracks 43, whereby the connection of the lever-type connector 10 and the mating connector 60 proceeds. When the lever 40 is at the connection completion position, the cam pins 65 are located at the final ends 43B of the tracks 43 as shown in FIG. 7. Conversely, if the lever 40 is moved from the connection completion position to the connection start position, the cam pins 65 are engaged with the inner walls of the tracks 43, whereby the separation of the lever-type connector 10 and the mating connector 60 proceeds.

### First Pressing Portion, Second Pressing Portion

As shown in FIG. 10, the lever 40 is provided with a second pressing portion 45 (an example of a pressing portion) projecting inward in a rotation radial direction from the operating portion 42 and a first pressing portion 44 (an example of the pressing portion) projecting further inward in the rotation radial direction from the second pressing portion 45. Here, the rotation radial direction is a direction orthogonal to an extension direction of the rotary shafts 26 (lateral direction) and passing through a center of rotation, and a direction toward the rotary shafts 26 is referred to as an inward direction and a direction away from the rotary shafts 26 is referred to as an outward direction. As shown in FIG. 4, the second pressing portion 45 is disposed in a lateral central part of the operating portion 42. The first pressing portion 44 is smaller than the second pressing portion 45 in the lateral direction and disposed in a lateral central part of the second pressing portion 45.

As shown in FIG. 14, the second pressing portion 45 includes a slide-contact portion 45A in the form of a curved surface. The slide-contact portion 45A is in the form of an arc, which is a part of a circle, substantially centered on the rotary shafts 26 in a side view. As shown in FIG. 16, the rear end surface of the second pressing portion 45 serves as the locking portion 45B on the basis of the posture of the lever 40 at the connection completion position. With the lever-type connector 10 and the mating connector 60 properly connected, the locking portion 45B is disposed to face the fitting lock portions 23B and the locking portion 45B and the fitting lock portions 23B are locked, whereby the lever 40 is restricted from rotating in a separation direction.

The first pressing portion 44 has a chevron shape projecting from the slide-contact portion 45A. The first pressing portion 44 is provided on a front side part of the slide-contact portion 45A on the basis of the posture of the lever 40 at the connection completion position.

### Detecting Member

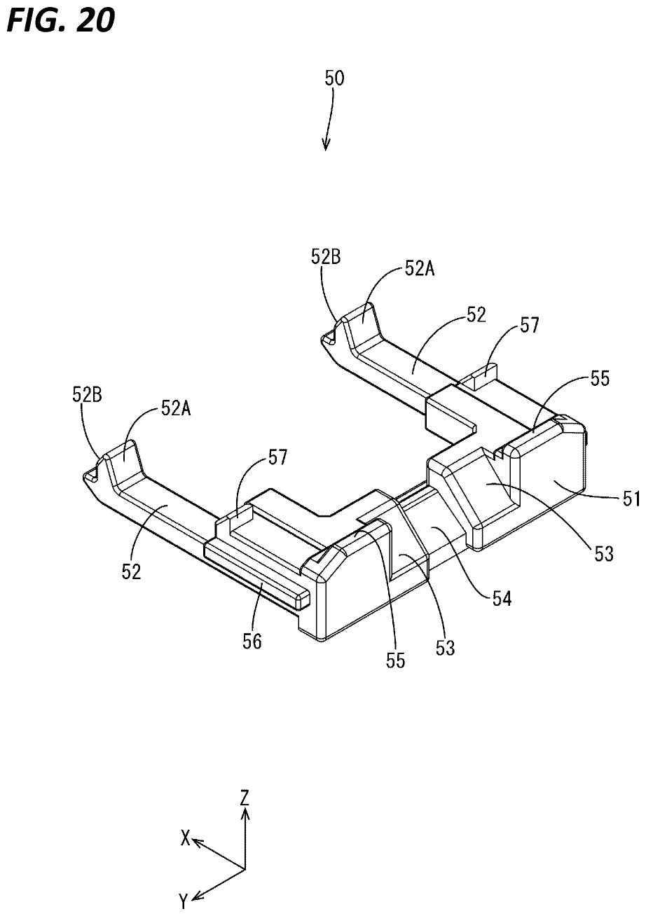

The detecting member 50 is made of synthetic resin. As shown in FIG. 20, the detecting member 50 includes a body portion 51, arm portions 52 extending from the body portion 51 and locking projections 52A disposed on tip parts of the arm portions 52. The body portion 51 has a substantially gate shape having both end parts in the width direction (lateral direction) extending forward. The arm portions 52 extend forward respectively from right and left end parts of the body portion 51. The arm portion 52 is deflectable and deformable in the vertical direction with a rear end part connected to the body portion 51 as a base end. The locking projection 52A is disposed at a position near a front end part of the arm portion 52 and projects upward from the arm portion 52. An inclined portion 52B is formed on an upper part of a front side part of the locking projection 52A. The inclined portion 52B is inclined downward toward the front (see FIG. 15). As shown in FIG. 9 and the like, the locking projection 52A is lockable to the first locking portion 27.

As shown in FIG. 20, a first recess 53 recessed from the body portion 51 and a second recess 54 further recessed from the bottom surface of the first recess 53 are formed in a laterally central part of the body portion 51. The second recess 54 is disposed in a lateral central part of the first recess 53. When the lever 40 is rotated, the first pressing portion 44 enters the second recess 54, and the second pressing portion 45 enters the first recess 53 (see FIGS. 4 and 12).

Operation ribs 55 are provided to extend further upward than the upper surface of the body portion 51 on a rear end part of the body portion 51. By placing fingers on the operation ribs 55 or the rear surface of the body portion 51 to operate the detecting member 50, the detecting member 50 can be moved between a standby position (see FIG. 9) and a detection position (see FIG. 18). In this embodiment, the detection position is disposed forward of the standby position, and the detecting member 50 is movable in the front-rear direction.

As shown in FIG. 5, the detecting member 50 is provided with two ridge portions 56 laterally projecting from both side surfaces of the body portion 51. The ridge portions 56 are accommodated into the engaging recesses 28. The ridge portions 56 slide in contact with the inner walls of the engaging recesses 28 to guide a movement of the detecting member 50.

As shown in FIG. 20, the detecting member 50 is provided with temporary locking portions 57 projecting from the upper surface of the body portion 51. The temporary locking portions 57 are provided on right and left side parts of the upper surface of the body portion 51. As shown in FIG. 9, a front side part of the temporary locking portion 57 is inclined to be located higher toward the rear. The rear end surface of the temporary locking portion 57 is an upright surface substantially orthogonal to an axis extending in the front-rear direction. The temporary locking portions 57 are disposed to be lockable to the temporary locking projections 29A with the detecting member 50 located at the standby position. By locking the temporary locking portions 57 and the temporary locking projections 29A, the detecting member 50 is suppressed from moving rearward from the standby position.

### Mounting of Detecting Member into Housing

The mounting of the detecting member 50 into the housing 20 is described. First, the arm portions 52 and side parts of the body portion 51 of the detecting member 50 are inserted into the first accommodation space SP1. After the arm portions 52 are disposed in the first accommodation space SP1, front end parts of the temporary locking portions 57 and rear end parts of the temporary locking projections 29A slide in contact and the temporary locking arm portions 29 are deflected and deformed upward. If the detecting member 50 is pushed further forward, the temporary locking projections 29A ride over the temporary locking portions 57. The temporary locking arm portions 29 return to a natural state and the detecting member 50 is disposed at the standby position. With the detecting member 50 located at the standby position, the locking projections 52A and the first locking portions 27 are locked, whereby a forward movement of the detecting member 50 is restricted. Further, the rear end surfaces of the temporary locking portions 57 and the front end surfaces of the temporary locking projections 29A are locked, whereby a rearward movement of the detecting member 50 is restricted.

### Connection Detection of Lever-Type Connector by Detecting Member

Next, the locking of the detecting member 50 and the housing 20 and connection detection by the detecting member 50 are described in correspondence with a connection procedure of the lever-type connector 10 and the mating connector 60.

The lever-type connector 10 having the detecting member 50 mounted at the standby position is positioned with respect to the mating connector 60 and the housing 20 is inserted into the fitting recess 64 (see FIGS. 1 and 6). Since the lever 40 is separated from the lock arm 23 as shown in FIG. 10 in a stage before the start of a connecting operation with shallow insertion, the lock arm 23 is in a natural state. Thus, the second locking portion 23D of the lock arm 23 is not arranged to face the body portion 51 of the detecting member 50 in the front-rear direction.

With the cam pins 65 located in the entrances 43A of the tracks 43, the operating portion 42 is operated and the lever 40 is rotated from the connection start position toward the connection completion position. As shown in FIG. 12, the first pressing portion 44 of the lever 40 first contacts the press starting portion 25 of the lock arm 23. In this way, the lock arm 23 is deflected and deformed downward and enters the first accommodation space SP1. In this way, the second locking portion 23D and the body portion 51 face each other in the front-rear direction. With the lock arm 23 deflected and deformed as just described, the second locking portion 23D and the body portion 51 are locked, whereby the detecting member 50 is restricted from moving forward toward the detection position.

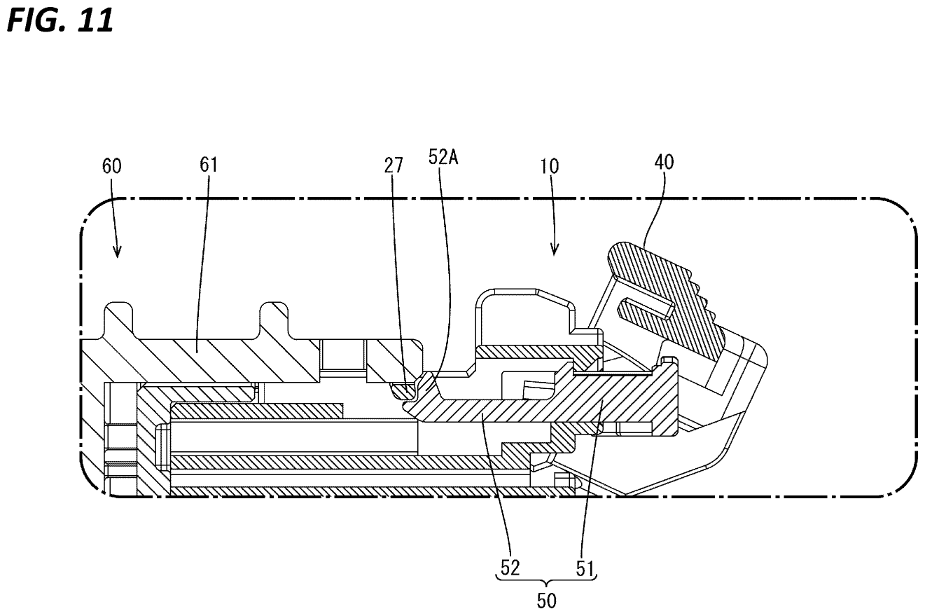

Further, the first locking portions 27 and the locking projections 52A are facing each other in the front-rear direction until the lever 40 reaches a position shown in FIG. 11 (at the same rotation angle as in FIG. 12) from the connection start position (see FIG. 9). Thus, a movement of the detecting member 50 to the detection position is restricted also by the locking of the first locking portions 27 and the locking projections 52A.

If the lever 40 is further rotated and approaches the connection completion position, the releasing projections 67 provided on the upper wall 64C of the mating housing 61 contact the locking projections 52A via the openings 27A of the housing 20 as shown in FIG. 13. In this way, the arm portions 52 are deflected and deformed downward and the locking of the locking projections 52A and the first locking portions 27 is released. Here, if the second locking portion 23D is not provided unlike this embodiment, the detecting member 50 is allowed to move to the detection position. That is, there is a possibility that the lever-type connector 10 and the mating connector 60 are erroneously detected to be properly connected although these connectors are not properly connected.

However, in this embodiment, with the lever 40 located at a position shown in FIG. 13, the lock arm 23 is pressed and deflected and deformed by the second pressing portion 45 following the first pressing portion 44 as shown in FIG. 14. In particular, the slide-contact portion 45A of the second pressing portion 45 and the sliding contact portion 24 slide in contact. Thus, the second locking portion 23D and the body portion 51 are lockable and the detecting member 50 cannot be moved to the detection position. Thus, the detecting member 50 does not move to the detection position at the rotation angle shown in FIGS. 13 and 14, wherefore proper connection is not erroneously detected.

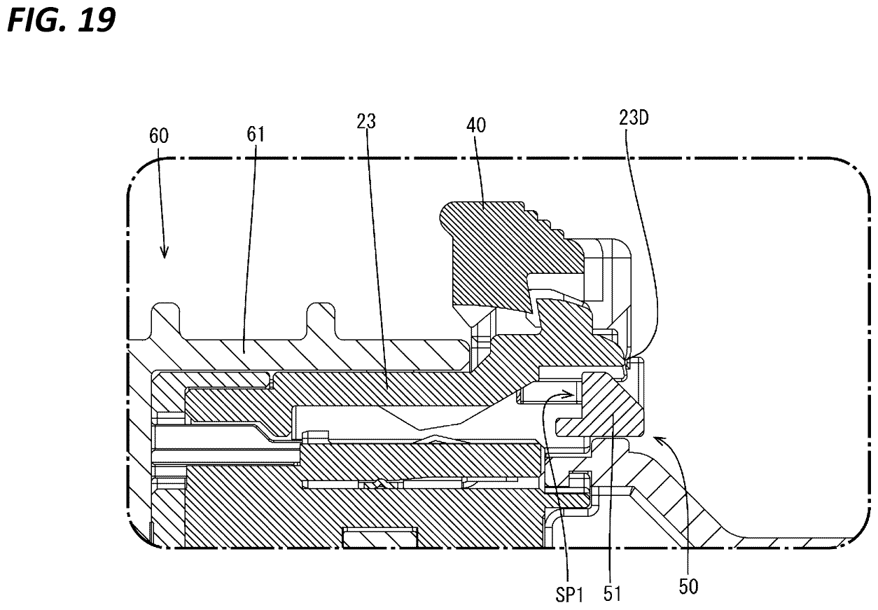

If the lever 40 is further rotated and reaches the connection completion position, the slide contact of the slide-contact portion 45A of the second pressing portion 45 and the sliding contact portion 24 is released and the lock arm 23 returns to the natural state as shown in FIG. 16. In this way, the locking portion 45B of the second pressing portion 45 and the fitting lock portions 23B of the lock arm 23 are lockably disposed. By locking the locking portion 45B and the fitting lock portions 23B, the lever 40 is suppressed from rotating from the connection completion position to the connection start position. Further, by a return of the lock arm 23 to the natural state, the second locking portion 23D and the body portion 51 are no longer facing each other in the front-rear direction and a forward movement of the detecting member 50 cannot be restricted by the second locking portion 23D. Therefore, as shown in FIG. 19, the detecting member 50 can be moved to the detection position and the proper connection of the mating connector 60 and the lever-type connector 10 can be detected.

In other words, since the lock arm 23 is deflected and deformed until the lever 40 reaches the connection completion position after starting to slide in contact with the lock arm 23, the second locking portion 23D and the body 51 are lockable and the detecting member 50 cannot be moved to the detection position. Thus, even in a state where the lever 40 is near the connection completion position, the erroneous detection of the proper connection can be avoided. That is, the reliability of the connection detection can be improved.

If the detecting member 50 is pushed forward with the lever 40 disposed at the connection completion position (see FIG. 16), the lateral central part of the body portion 51 is accommodated into the first accommodation space SP1 (see FIG. 19). In the second accommodation spaces SP2, if the detecting member 50 is pushed forward with the lever 40 disposed at the connection completion position (see FIG. 15), the first locking portions 27 and the inclined portions 52B of the locking projections 52A slide in contact and the locking projections 52A sink to below the first locking portions 27. The first locking portions 27 ride over the locking projections 52A and the arm portions 52 return to a natural state, whereby the detecting member 50 reaches the detection position (see FIG. 18). With the detecting member 50 located at the detection position, the locking projections 52A are disposed in the window portions 66 of the mating housing 61. By locking the rear end surfaces of the locking projections 52A and the front end surfaces of the first locking portions 27, the detecting member 50 is restricted from moving from the detection position to the standby position. When the detecting member 50 is moved from the detection position to the standby position, a jig or the like is hooked to front parts of the operation ribs 55 to move the detecting member 50 rearward.

### Connection Detection of Lever-Type Connector by Detection Terminal

Next, connection detection by the detection terminal 30 is described in correspondence with the connection procedure of the lever-type connector 10 and the mating connector 60.

In the stage before the start of the connecting operation with shallow insertion, the lock arm 23 is separated from the lever 40 as shown in FIG. 8, wherefore the lock arm 23 and the detection terminal 30 are in the natural state. Further, the detection terminal 30 and the mating detection terminals 63 are separated in a connection direction (front-rear direction).

In the lever 40 is rotated from the connection start position toward the connection completion position, the first pressing portion 44 contacts the press starting portion 25 and the lock arm 23 is deflected and deformed downward as shown in FIG. 12. The projection 23C of the lock arm 23 presses the engaging portion 34 of the detection terminal 30 and deflects and deforms the spring portion 32 downward. In this way, the contact point portions 33 of the detection terminal 30 are pushed down to positions lower than the mating detection terminals 63.

If the lever 40 is further rotated, the second pressing portion 45 presses the lock arm 23, following the first pressing portion 44, and a state where the lock arm 23 is deflected and deformed is maintained (see FIG. 14). Therefore, the connection of the lever-type connector 10 and the mating connector 60 proceeds with the contact point portions 33 disposed at positions not interfering with the mating detection terminals 63.

When the lever 40 reaches the connection completion position, the lock arm 23 returns to the natural state and the connection of the lever-type connector 10 and the mating connector 60 is completed. As shown in FIG. 17, as the lock arm 23 resiliently returns, the spring portion 32 also tries to resiliently return to an initial position and the contact point portions 33 contact the mating detection terminals 63. Since the detection circuit is formed by the detection terminal 30 and the mating detection terminals 63 in this way, the proper connection of the mating connector 60 and the lever-type connector 10 can be confirmed through the electrical conduction of the both.

As described above, since the detection terminal 30 and the mating detection terminals 63 are connected to form the detection circuit as the deflection and deformation of the lock arm 23 is released also for connection detection by the detection terminal 30, the reliability of the connection detection can be improved.

### Concerning Pressing of Lock Arm by First Pressing Portion and Second Pressing Portion

In this embodiment, although not shown in detail, the second pressing portion 45 is configured to start to press the lock arm 23 with the first pressing portion 44 pressing the lock arm 23 in a rotation process of the lever 40 from the connection start position toward the connection completion position. In this way, the deflected and deformed state of the lock arm 23 is maintained until the second pressing portion 45 stops pressing the lock arm 23 after the first pressing portion 44 starts to press the lock arm 23.

Since the first and second pressing portions 44, 45 are provided in this embodiment, the lock arm 23 can continue to be pressed in a wide rotation angle range as compared to the case where only one pressing portion is provided. Thus, the lever-type connector 10 and the mating connector 60 can be connected in a large rotation angle range, wherefore a connection stroke is easily increased and an effective contact margin of the detection terminal 30 and the mating detection terminals 63 is easily ensured. Further, an effect of reducing a connection force by the lever 40 is easily obtained.

### Functions and Effects of Embodiment

According to this embodiment, the following functions and effects are achieved.

The lever-type connector 10 according to the embodiment is connectable to the mating connector 60, and provided with the housing 20, the lever 40 rotatably mounted on the housing 20 between the connection start position and the connection completion position, and the detecting member 50 mounted in the housing 20 movably between the standby position and the detection position, the detecting member being allowed to move from the standby position to the detection position with the lever 40 located at the connection completion position. The housing 20 includes the first locking portions 27 for restricting a movement of the detecting member 50 from the standby position to the detection position by being locked to the detecting member 50 with the lever located at the connection start position and the lock arm 23 for locking the lever 40 with the lever 40 located at the connection completion position. The lock arm 23 includes the second locking portion 23D for restricting the movement of the detecting member 50 from the standby position to the detection position by locking the detecting member 50, and the second locking portion 23D is disposed to be lockable to the detecting member 50 by the lock arm 23 sliding in contact with the lever 40 to be deflected and deformed in the rotation process of the lever 40 from the connection start position toward the connection completion position. The first locking portions 27 are disposed to be lockable to the detecting member 50 until the second locking portion 23D becomes lockable to the detecting member 50 in the rotation process of the lever 40 from the connection start position toward the connection completion position.

According to this configuration, since the lock arm 23 includes the second locking portion 23D and the second locking portion 23D is disposed to be lockable to the detecting member 50 by the deflection and deformation of the lock arm 23, even if the detecting member 50 is strongly pushed in with the lever-type connector 10 and the mating connector 60 nearly properly connected, a movement of the detecting member 50 from the standby position to the detection position is restricted by the second locking portion 23D. On the other hand, if the lever-type connector 10 and the mating connector 60 are properly connected, the lock arm 23 resiliently returns and the second locking portion 23D is separated from the detecting member 50 and the detecting member 50 becomes movable to the detection position. By providing the second locking portion 23D lockable to the detecting member 50 as the lock arm 23 is deflected and deformed in this way, the reliability of the connection detection of the lever-type connector 10 can be improved.

In this embodiment, the detecting member 50 includes the body portion 51, the deflectable and deformable arm portions 52 extending from the body portion 51 and the locking projections 52A disposed on the tip parts of the arm portions 52. The body portion 51 is lockable to the second locking portion 23D. The locking projections 52A are locked to the first locking portions 27 with the lever 40 located at the connection start position. In the rotation process of the lever 40 from the connection start position toward the connection completion position, the locking projections 52A interfere with the mating connector 60 and the arm portions 52 are deflected and deformed, whereby the locking of the locking projections 52A and the first locking portions 27 is released.

According to this configuration, as the connection of the lever-type connector 10 and the mating connector 60 proceeds, the locking of the first locking portions 27 and the locking projections 52A can be released. Further, even if the locking of the first locking portions 27 and the locking projections 52A is released, the second locking portion 23D and the body portion 51 can be lockable.

The lever-type connector 10 according to this embodiment is further provided with the detection terminal 30 held in the housing 20 and configured to form the detection circuit by contacting the mating detection terminals 63 provided in the mating connector 60. The lock arm 23 is disposed to face the detection terminal 30. The lever 40 includes the pressing portions (first pressing portion 44 and second pressing portion 45) for separating the detection terminal 30 and the mating detection terminals 63 by pressing the lock arm 23 toward the detection terminal 30. When the lever 40 reaches the connection completion position, the pressing of the lock arm 23 by the pressing portions is released and the detection terminal 30 contacts the mating detection terminals 63.

According to this configuration, if the lever-type connector 10 and the mating connector 60 are properly connected, the lock arm 23 resiliently returns and the detection terminal 30 and the mating detection terminals 63 contact to form the detection circuit. Therefore, the connection detection can be made also by the detection circuit in addition to by the detecting member 50.

### Other Embodiments

(1) Although the mating connector 60 is provided with three fitting recesses 64 in the above embodiment, there is no limitation to this and the number of fitting recesses of a mating connector may be one, two, four or more.
(2) Although the two first locking portions 27 and two locking projections 52A are provided in the above embodiment, there is no limitation to this and one, three or more first locking portions and one, three or more locking projections may be provided.
(3) Although the first and second pressing portions 44, 45 are illustrated as the pressing portions in the above embodiment, there is no limitation to this and only one pressing portion may be provided.
(4) Although the lever-type connector 10 is provided with the detection terminal 30 and the mating connector 60 is provided with the mating detection terminals 63 in the above embodiment, there is no limitation to this and the detection terminal and the mating detection terminals may not be provided.

### LIST OF REFERENCE NUMERALS

10: lever-type connector
20: housing
21: terminal accommodating portion
22: detection terminal accommodating portion
23: lock arm
23A: lock arm body
23B: fitting lock portion
23C: projection
23D: second locking portion
24: sliding contact portion
25: press starting portion
26: rotary shaft
27: first locking portion
27A: opening
28: engaging recess
29: temporary locking arm portion
29A: temporary locking projection
30: detection terminal
31: base plate portion
32: spring portion
33: contact point portion
34: engaging portion
40: lever
41: cam plate
41A: shaft hole
42: operating portion
43: track
43A: entrance
43B: final end
44: first pressing portion
45: second pressing portion
45A: slide-contact portion
45B: locking portion
50: detecting member
51: body portion
52: arm portion
52A: locking projection
52B: inclined portion
53: first recess
54: second recess
55: operation rib
56: ridge portion
57: temporary locking portion
60: mating connector
61: mating housing
62: mating terminal
63: mating detection terminal
64: fitting recess
64A: side wall
64B: back wall
64C: upper wall
65: cam pin
66: window portion
67: releasing projection
SP1: first accommodation space
SP2: second accommodation space
SP: accommodation space

1. A lever-type connector connectable to a mating connector, comprising:
a housing;
a lever mounted on the housing rotatably between a connection start position and a connection completion position; and
a detecting member mounted in the housing movably between a standby position and a detection position, the detecting member being allowed to move from the standby position to the detection position with the lever located at the connection completion position,
the housing including a first locking portion for restricting a movement of the detecting member from the standby position to the detection position by being locked to the detecting member with the lever located at the connection start position and a lock arm for locking the lever with the lever located at the connection completion position,
the lock arm including a second locking portion for restricting the movement of the detecting member from the standby position to the detection position by locking the detecting member,
the second locking portion being disposed to be lockable to the detecting member by the lock arm sliding in contact with the lever to be deflected and deformed in a rotation process of the lever from the connection start position toward the connection completion position, and
the first locking portion being disposed to be lockable to the detecting member until the second locking portion becomes lockable to the detecting member in the rotation process of the lever from the connection start position toward the connection completion position.

2. The lever-type connector of claim 1, wherein:
the detecting member includes a body portion, a deflectable and deformable arm portion extending from the body portion and a locking projection disposed on a tip part of the arm portion,
the body portion is lockable to the second locking portion,
the locking projection is locked to the first locking portion with the lever located at the connection start position, and
the locking projection interferes with the mating connector and the arm portion is deflected and deformed in the rotation process of the lever from the connection start position toward the connection completion position, whereby locking of the locking projection and the first locking portion is released.

3. The lever-type connector of claim 1, further comprising a detection terminal held in the housing, the detection terminal forming a detection circuit by contacting a mating detection terminal provided in the mating connector, wherein:
the lock arm is disposed to face the detection terminal,
the lever includes a pressing portion for separating the detection terminal from the mating detection terminal by pressing the lock arm toward the detection terminal, and
pressing of the lock arm by the pressing portion is released and the detection terminal contacts the mating detection terminal when the lever reaches the connection completion position.
